(19) United States
(12) Patent Application Publication
(10) Pub. No.: US 2020/0272291 A1
(43) Pub. Date: Aug. 27, 2020

(54) INTERFACE DISPLAY METHOD AND APPARATUS

(71) Applicant: Alibaba Group Holding Limited, Grand Cayman (KY)

(72) Inventors: Haixin Wang, Beijing (CN); Yi WU, Beijing (CN); Wenbo LI, Beijing (CN)

(21) Appl. No.: 15/931,414

(22) Filed: May 13, 2020

Related U.S. Application Data
(63) Continuation of application No. PCT/CN2018/105264, filed on Sep. 12, 2018.

(30) Foreign Application Priority Data
Nov. 14, 2017 (CN) 201711121870.4

(51) Int. Cl. G06F 3/0484

(52) U.S. Cl. CPC G06F 3/0484

(57) ABSTRACT

A method including upon detecting a movement of an interface, determining whether the movement satisfies a trigger condition for a dynamic display effect; when the trigger condition is satisfied, displaying information related to content in the interface with the dynamic display effect. Under the interface display method and apparatus according to the example embodiments of the present disclosure, when a detected movement of an interface satisfies a trigger condition for a dynamic display effect, information related to content in the interface is displayed with the dynamic display effect, which makes the interface display more interesting. Moreover, in the process of viewing an image displayed in the interface, a user may determine the content displayed in the interface by viewing the information displayed with the dynamic display effect, thereby preventing content of interest from being missed and saving viewing time.

### CROSS REFERENCE TO RELATED PATENT APPLICATIONS

This application claims priority to and is a continuation of PCT Patent Application No. PCT/CN2018/105264, filed on 12 Sep. 2018 and entitled “INTERFACE DISPLAY METHOD AND APPARATUS,” which claims priority to Chinese Patent Application No. 201711121870.4, filed on 14 Nov. 2017 and entitled “INTERFACE DISPLAY METHOD AND APPARATUS,” which are incorporated herein by reference in their entirety.

### TECHNICAL FIELD

The present disclosure relates to the field of computer technologies, and, more particularly, to interface display methods and apparatuses.

### BACKGROUND

In conventional techniques, a user often controls an interface to move through an operation, such as sliding or dragging, on a terminal device like a cell phone, so as to browse (or referred to as scan) content displayed in the interface and to look for content of interest. However, in a process where the user operates to control the interface to move rapidly, the content in the interface does not change, but only moves rapidly in the direction of sliding or dragging by the user. In addition, when the moving speed is too fast or there is too much content, it would be difficult for the user to promptly and clearly view the content displayed in the interface by browsing rapidly, or may even miss content of interest. Therefore, the user's needs may not be met.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides interface display methods and apparatuses to solve the problem that a user is unable to promptly and clearly view content displayed in an interface or may even miss content of interest in an interface display process.

According to an example embodiment of the present disclosure, an interface display method is provided, comprising:

upon detecting a movement of an interface, determining whether the movement satisfies a trigger condition for a dynamic display effect; and

when the trigger condition is satisfied, displaying information related to content in the interface with the dynamic display effect.

With regard to the above-described method, in an example implementation manner, the determining whether the movement satisfies a trigger condition for a dynamic display effect comprises:

determining whether a speed of the interface movement exceeds a speed threshold; and

when the speed of the interface movement exceeds the speed threshold, deciding that the movement satisfies the trigger condition for the dynamic display effect.

With regard to the above-described method, in an example implementation manner, the displaying information related to content in the interface with the dynamic display effect comprises:

at an image in the interface, displaying a person or thing related to the image with the dynamic display effect.

With regard to the above-described method, in an example implementation manner, the displaying information related to content in the interface with the dynamic display effect comprises:

displaying an image in the interface with the dynamic display effect.

With regard to the above-described method, in an example implementation manner, the displaying information related to content in the interface with the dynamic display effect comprises:

displaying an animated image in the interface with the dynamic display effect, the animated image being capable of outputting prompt information related to the content in the interface.

With regard to the above-described method, in an example implementation manner, the displaying information related to content in the interface with the dynamic display effect comprises:

determining matching information in the information related to the content in the interface that matches a historical behavior of the user; and

displaying the matching information with the dynamic display effect.

According to an example embodiment of the present disclosure, an interface display apparatus is provided, comprising:

an interface detecting module configured to, upon detecting a movement of an interface, determine whether the movement satisfies a trigger condition for a dynamic display effect; and

a dynamic display module configured to, when the trigger condition is satisfied, display information related to content in the interface with the dynamic display effect.

With regard to the above-described apparatus, in an example implementation manner, the interface detecting module comprises:

a determining sub-module configured to determine whether a speed of the interface movement exceeds a speed threshold; and

a deciding sub-module configured to, when the speed of the interface movement exceeds the speed threshold, decide that the movement satisfies the trigger condition for the dynamic display effect.

With regard to the above-described apparatus, in an example implementation manner, the dynamic display module comprises:

a first display sub-module configured to, on an image in the interface, display a person related to the image with the dynamic display effect.

With regard to the above-described apparatus, in an example implementation manner, the dynamic display module comprises:

a second display sub-module configured to display an image in the interface with the dynamic display effect.

With regard to the above-described apparatus, in an example implementation manner, the dynamic display module comprises:

a third display sub-module configured to display an animated image in the interface with the dynamic display effect, the animated image being capable of outputting prompt information related to the content in the interface.

With regard to the above-described apparatus, in an example implementation manner, the dynamic display module comprises:

a matching sub-module configured to determine matching information in the information related to the content in the interface that matches a historical behavior of the user; and

a fourth display sub-module configured to display the matching information with the dynamic display effect.

According to an example embodiment of the present disclosure, an interface display apparatus is provided, comprising: one or more processor, and one or more memories storing computer-readable instructions that, executable by the one or more processors, cause the one or more processors to perform the above-described interface display method.

According to an example embodiment of the present disclosure, a non-volatile computer readable storage medium is provided, which stores computer-readable instructions that, executable by one or more processors, cause the one or more processors to perform the above-described interface display method.

When a detected movement of an interface satisfies a trigger condition for a dynamic display effect, the interface display method and apparatus according to example embodiments of the present disclosure display information related to content in the interface with the dynamic display effect and make the interface display more interesting. In addition, when viewing an image displayed in the interface, a user may be able to determine content displayed in the interface by viewing the information displayed with the dynamic display effect. As a result, content of interest is not missed, and the viewing time is saved.

According to the following detailed description of example embodiments with reference to the accompanying drawings, the features of the present disclosure will become clear.

### BRIEF DESCRIPTION OF THE DRAWINGS

The accompanying drawings described here are used to provide further understanding of the present disclosure and constitute a part of the present disclosure. The example embodiments of the present disclosure and the description of the example embodiments are used to illustrate the present disclosure, and do not constitute any limitation to the present disclosure.

FIG. 1 is a flow chart of an interface display method according to an example embodiment of the present disclosure;

FIG. 2 is a flow chart of Step S102 in the interface display method according to an example embodiment of the present disclosure;

FIG. 3 is a flow chart of Step S104 in the interface display method according to an example embodiment of the present disclosure;

FIG. 4a is a schematic diagram of an application example of the interface display method according to an example embodiment of the present disclosure;

FIG. 4b is a schematic diagram of an application example of the interface display method according to an example embodiment of the present disclosure;

FIG. 4c is a schematic diagram of an application example of the interface display method according to an example embodiment of the present disclosure;

FIG. 5 is a block diagram of an interface display apparatus according to an example embodiment of the present disclosure;

FIG. 6 is a block diagram of an interface display apparatus according to an example embodiment of the present disclosure; and

FIG. 7 is a block diagram for an interface display apparatus according to an example embodiment of the present disclosure.

### DETAILED DESCRIPTION

Various example embodiments, features and aspects of the present disclosure will be described in detail below with reference to the accompanying drawings. Identical legends in the accompanying drawings represent elements with identical or similar functions. Although various aspects of the example embodiments are shown in the accompanying drawings, the accompanying drawings are not necessarily plotted to scale, unless particularly stated otherwise.

The special term “example” used herein means “as an example, example embodiment or being explanatory.” Any example embodiment described as being “example” may not necessarily be explained as being superior to or better than other example embodiments.

In addition, to better describe the present disclosure, numerous specific details are provided in specific implementation manners below. Those skilled in the art better should understand that the present disclosure may still be implemented even without some specific details. In some examples, methods, means, elements, and circuits that are known to those skilled in the art are not described in detail, so as to highlight the subject matter of the present disclosure.

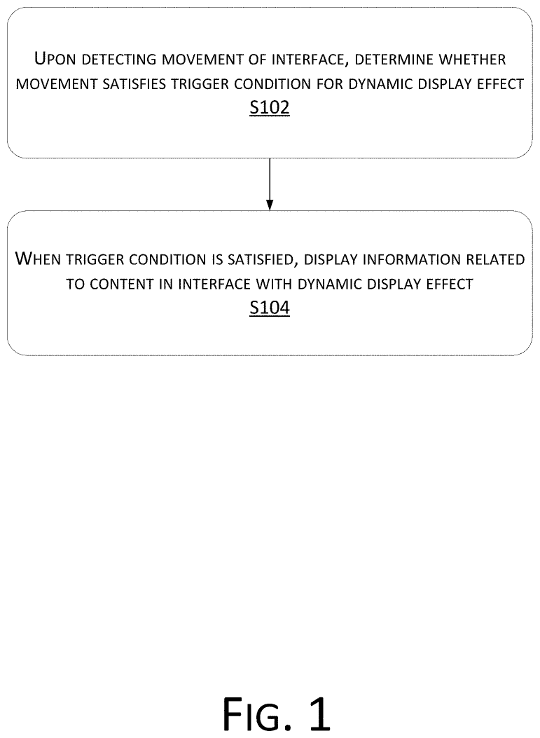

FIG. 1 is a flow chart of an interface display method according to an example embodiment of the present disclosure. As shown in FIG. 1, this method may be applied to a terminal device and may comprise Step S102 and Step S104.

In Step S102, upon detecting a movement of an interface, whether the movement satisfies a trigger condition for a dynamic display effect is determined.

In the present example embodiment, a speed of the interface movement may be obtained, and then, it is determined, according to the speed of the interface movement, whether the movement satisfies a trigger condition for a dynamic display effect.

In the present example embodiment, the terminal device may be any device, such as a cell phone, a tablet computer, a smart watch, a vehicle-mounted terminal, an MP3 player, a Virtual Reality (VR) head-mounted display, VR glasses, an Augmented Reality (AR) head-mounted display, AR glasses, a Mixed Reality (MR) head-mounted display, MR glasses, Head Up Display (HUD), or a smart TV, which is not limited in the present disclosure. This device has functions of displaying videos, audios or other content related to human senses of vision, hearing, smell, touch, and taste. The interface may be an interface related to multimedia resources, such as videos, audios, images, etc. A user may directly move the interface by sliding a finger, or may move the interface by means of an auxiliary control device, such as a handle, a mouse, etc. Moreover, as assisted by a relevant device, the user may also move the interface through a look, a thought (e.g., a brain wave), a gesture, etc., which is not limited in the present disclosure.

In Step S104, when the trigger condition is satisfied, information related to content in the interface is displayed with the dynamic display effect.

In the present example embodiment, the trigger condition may be set according to content of images displayed by the interface, a speed at which the user views the images, etc. For example, in the situation that the speed of the interface movement exceeds a speed at which the user can clearly view content in the images, it may be determined that the movement satisfies the trigger condition, which is not limited in the present disclosure.

In the present example embodiment, the content in the interface may be any content displayed or comprised in the interface, for example, posters and introductions of videos, interactive content (e.g., instant messages), project lists, links, products, etc. that are displayed in the interface. The information related to the content in the interface may be information in any form, such as images, texts, etc. The information may be a part of the content in the interface, or may be information that is related to the content in the interface and does not appear in the interface.

For example, the information related to the content in the interface may comprise a person, an animal, or a cartoon image related to the content in the interface, or may be a headshot, a half-length photo, or a full-length photo of the person, the animal, or the cartoon image, such as a headshot of a contact in instant messaging displayed in the interface, a headshot of a user of an account on a social website displayed in the interface, headshots, half-length photos, or full-length photos of characters in thumbnails, posters, and introductions of video resources like movies, TV shows, and the like displayed in the interface, or headshots, half-length photos, or full-length photos of people who appear in variety shows. The information related to the content in the interface may comprise a headshot, a half-length photo, or a full-length photo of an actor/actress related to the content. For example, if the content in the interface is video resources like movies, TV shows, and the like, the information related to the content in the interface may be headshots, half-length photos, or full-length photos of actors/actresses who play roles. The information related to the content in the interface may also comprise images themselves that correspond to the content in the interface, such as video thumbnails displayed in the interface. The information related to the content in the interface may also comprise a preset animated image corresponding to the content. The information related to the content in the interface may also comprise information that describes a product, such as a product trademark, displayed in the interface. Those skilled in the art may set, according to actual needs, specific content of the information related to the content in the interface, which is not limited in the present disclosure.

In the present example embodiment, the dynamic display effect may be dynamic display of the information related to the content in the interface implemented by means of dynamic images (e.g., dynamic images in the Graphics Interchange Format (GIF)), animations, and the like. Those skilled in the art may set the dynamic display effect according to actual needs, which is not limited in the present disclosure.

In the present example embodiment, a floating layer may cover an image in the interface, and the above-described information may be displayed with the dynamic display effect in the floating layer. A region corresponding to the information displayed in the dynamic display effect may be opaque or translucent. The information displayed with the dynamic display effect may be displayed, for example, in a manner of highlighted display through centered display, enlarged display, and the like in the floating layer. Those skilled in the art may set, according to actual needs, display positions, display forms, and the like of the information displayed with the dynamic display effect, which is not limited in the present disclosure.

In an example implementation manner, in the situation where the information related to the content in the interface is displayed with the dynamic display effect, if the interface movement changes from satisfying the trigger condition for the dynamic display effect to not satisfying the trigger condition for the dynamic display effect, then the display of the information related to the content in the interface with the dynamic display effect is maintained within a display maintaining period, or the display of the information related to the content in the interface with the dynamic display effect is stopped. The display maintaining period may be set according to a degree of complexity of the content in the interface. The more complex the content, the longer the maintaining period, which is not limited in the present disclosure.

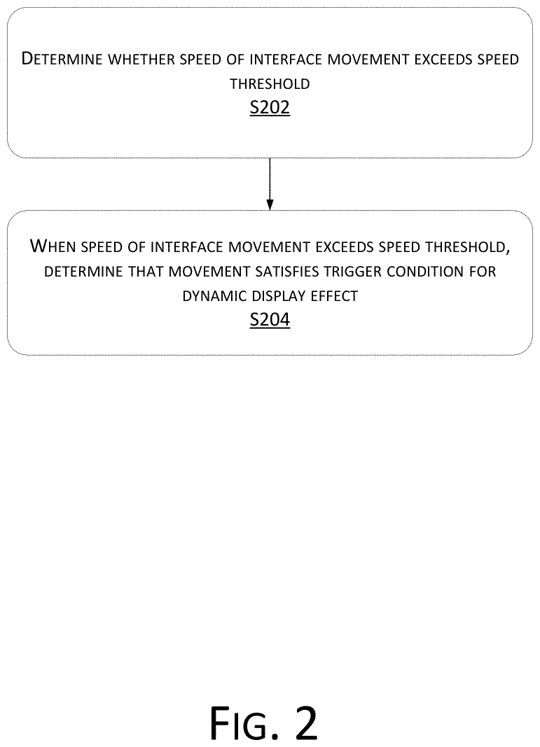

FIG. 2 is a flow chart of Step S102 in the interface display method according to an example embodiment of the present disclosure.

In an example implementation manner, as shown in FIG. 2, Step S102 may comprise Step S202 and Step S204.

In Step S202, whether a speed of the interface movement exceeds a speed threshold is determined.

In this implementation manner, the speed threshold may be determined according to the degree of complexity of the content in the interface and reading speeds of a user for contents having different degrees of complexity. When the interface displays more contents that are more complex, the user is slower in reading and understanding, and the speed threshold is smaller.

In Step S204, when the speed of the interface movement exceeds the speed threshold, the movement is determined to satisfy the trigger condition for the dynamic display effect.

In this implementation manner, the speed of the interface movement exceeding the speed threshold may mean that the speed of the interface movement is greater than or equal to the speed threshold. In this way, when the speed of the interface movement exceeds the speed threshold, the information related to the content in the interface may be displayed with the dynamic display effect for the user, which ensures that the user may also obtain specific content comprised in the interface when the speed of the interface movement is relatively fast.

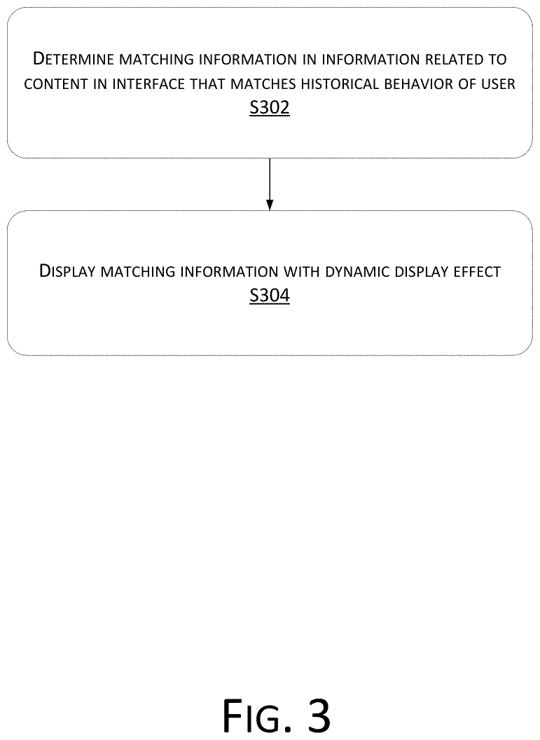

FIG. 3 is a flow chart of Step S104 in the interface display method according to an example embodiment of the present disclosure.

In an example implementation manner, as shown in FIG. 3, Step S104 may comprise Step S302 and Step S304.

In Step S302, matching information in the information related to the content in the interface that matches a historical behavior of the user is determined.

In this implementation manner, a historical behavior of the user may be determined according to a browsing record, a searching record, and the like of the user, and then matching information in the information related to the content in the interface that matches the historical behavior of the user may be determined. For example, it is determined, according to historical behaviors, that the user likes to watch comedy movies. If the movie A is a comedy in the content in the interface, the information related to the movie A is determined to be matching information. Those skilled in the art may set, according to actual needs, the manner in which a historical behavior of the user is obtained, which is not limited in the present disclosure.

In Step S304, the matching information is displayed with the dynamic display effect.

In this way, the matching information determined based on the historical behavior of the user may be displayed with the dynamic display effect for the user, to highlight the matching information that may be of interest to the user in a displayed image, to prevent the user from missing the content of interest, and to save the selection time for the user.

In an example implementation manner, the displaying the information related to the content in the interface with the dynamic display effect in Step S104 may comprise on an image in the interface, displaying a person related to the image with the dynamic display effect.

In this implementation manner, in the situation where the information related to the content in the interface is a person, the person may be displayed with the dynamic display effect in a region corresponding to the person in the interface. For example, a plurality of images of the person may be obtained in advance, a dynamic image may be generated according to the obtained plurality of images, and then the generated dynamic image may be played in the region corresponding to the person in the interface. Those skilled in the art may set, according to actual needs, a specific implementation manner of displaying a person in the interface with the dynamic display effect, which is not limited in the present disclosure. The person related to the image may be a person displayed in the image or may be a person related to the image but not displayed in the image.

In this way, the user may determine specific content displayed in the corresponding region in the interface through the dynamically displayed person, and may determine whether the content is of interest by displaying the person with the dynamic display effect. The viewing manner is simple, and the user's time is saved.

In an example implementation manner, the displaying the information related to the content in the interface with the dynamic display effect in Step S104 may comprise displaying an image in the interface with the dynamic display effect.

In this implementation manner, in the situation where the information related to the content in the interface is an image in the interface, a plurality of images (e.g., posters, thumbnails, etc.) corresponding to the image related to the content in the interface may be obtained in advance, a dynamic image may be generated according to the obtained plurality of images, and then the generated dynamic image may be played in a corresponding region. Those skilled in the art may set, according to actual needs, a specific implementation manner of displaying an image in the interface with the dynamic display effect, which is not limited in the present disclosure.

In this way, the user may determine specific content displayed in the corresponding region in the interface through the dynamically displayed image, and may determine an introduction of the content of the corresponding region from the dynamically displayed image. The viewing manner is simple, and the viewing time is saved.

In an example implementation manner, the displaying the information related to the content in the interface with the dynamic display effect in Step S104 may comprise: displaying an animated image in the interface with the dynamic display effect, the animated image being capable of outputting prompt information related to the content in the interface.

In this implementation manner, the animated image may be generated according to the content in the interface. For example, if the content in the interface is a movie B, a corresponding animated image may be generated according to the specific content of the movie B, and then the generated animated image may be displayed with the dynamic display effect. Moreover, a template for a plurality of animated images may be generated, and then a corresponding animated image may be generated according to the template of animated images and the content in the interface. For example, templates of animated images corresponding to different types of movies may be generated, including a horror movie template, a comedy movie template, an action movie template, etc. Subsequently, when the content displayed in the interface is a movie C, a type of the movie C and headshots of characters in the movie C are determined, and then a corresponding movie template C′ is determined according to the type of the movie C. Lastly, the headshots of characters in the movie C are embedded in the movie template C′ to generate an animated image. Alternatively, the same animated image that is not related to the content in the interface may be displayed. Those skilled in the art may set, according to actual needs, a specific implementation manner of displaying an animated image with the dynamic display effect and of generating an animated image, which is not limited in the present disclosure.

The animated image may output prompt information related to the content in the interface in any manner, such as an action, an expression, a voice, a text prompt, etc.

In this way, the user may determine specific content displayed in the corresponding region in the interface through the animated image and prompt information thereof, which makes the display more interesting, further helps the user view the image, and saves time for the user.

In an example implementation manner, a person in an image displayed with the dynamic display effect, an image in the interface, and an animated image may be highlighted in the display through highlighting, adding a frame, emitting light, etc., so as to increase the attention from the user and prevent the user from missing the content of interest. Those skilled in the art may set a manner of highlighted display according to actual needs, which is not limited in the present disclosure.

It should be noted that the above-described example embodiments are used as examples to describe the interface display method as above, but those skilled in the art should understand that the present disclosure is not limited thereto. In fact, a user may flexibly set all steps completely according to personal preference and/or practical application scenarios, as long as they comply with the technical solutions of the present disclosure.

With the interface display method according to the example embodiments of the present disclosure, when a detected movement of an interface satisfies a trigger condition for a dynamic display effect, information related to content in the interface is displayed with the dynamic display effect, which makes the interface display more interesting. Moreover, in the process of viewing an image displayed in the interface, a user may determine the content displayed in the interface by viewing the information displayed with the dynamic display effect, thereby preventing content of interest from being missed and saving viewing time.

### Application Example

With “screening movies” as an example application scenario below, an application example of the example embodiments of the present disclosure is provided below to facilitate the understanding of the flow of the interface display method. Those skilled in the art should understand that the application example below is merely for the purpose of facilitating the understanding of the example embodiments of the present disclosure, and may not be construed as a limitation to the example embodiments of the present disclosure.

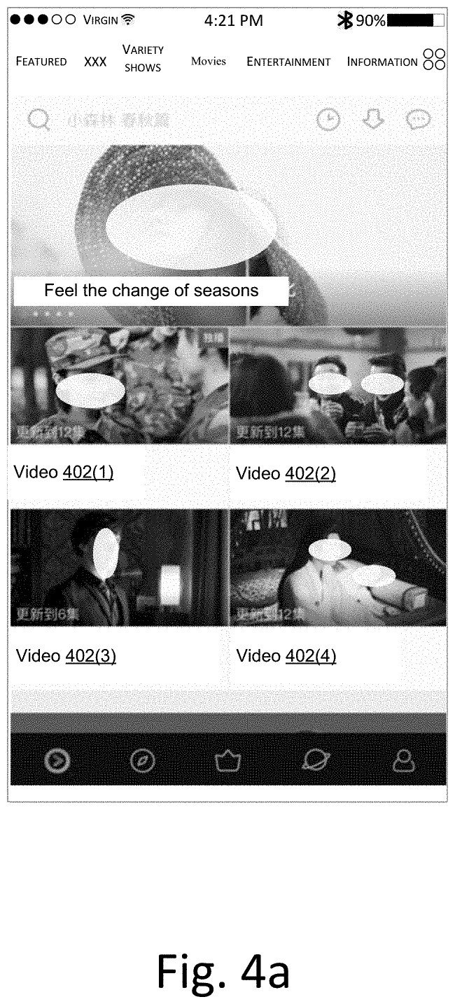

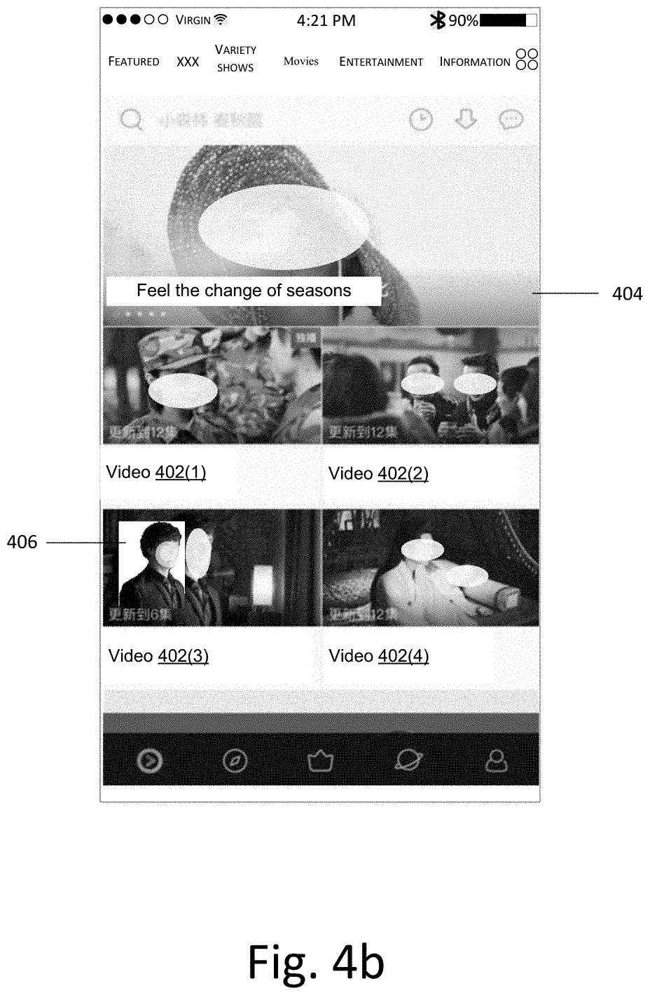

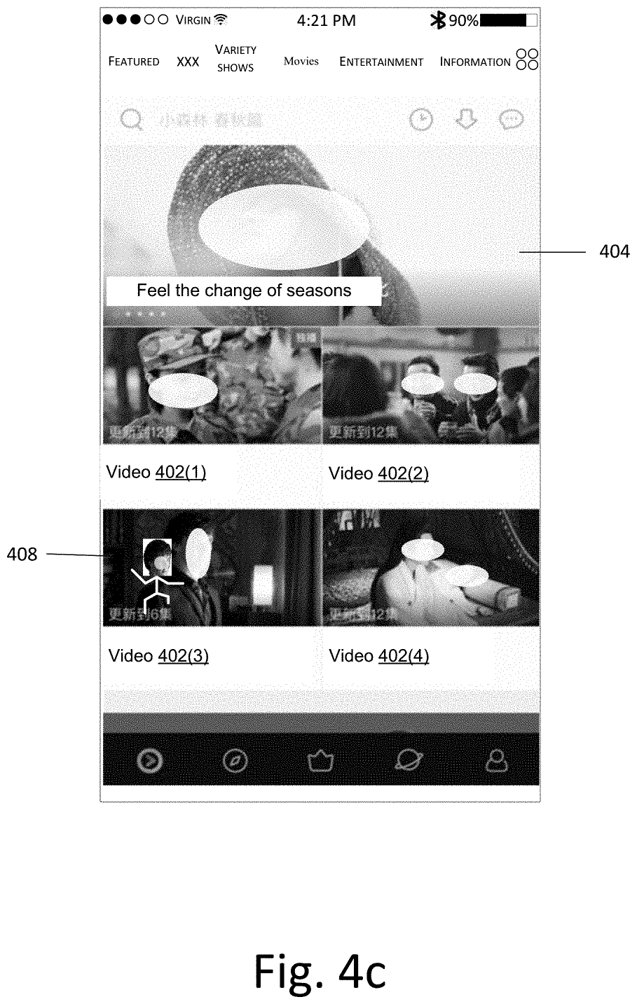

FIG. 4a is a schematic diagram of an application example of the interface display method according to an example embodiment of the present disclosure. As shown in FIG. 4a, when the interface display method according to the present disclosure is not used, only to-be-selected videos such as movies are displayed in the interface in the process that a user screens movies through video client software, and information related to the movies in the interface is not displayed with a dynamic display effect. For example, videos 402(1), 402(2), 402(3), and 402(4) are displayed in FIG. 4a

According to the conventional techniques, in a process that the user operates to control the interface to move rapidly, the content in the interface, such as elements related to the movies, does not change, but only moves rapidly in the direction indicated by the user. However, since the moving speed is relatively fast, the user may very likely miss movies of interest. For example, the human faces in the videos are identified as circles. To the users, the human faces represented by the circles do not change when the user moves the interface and the user may miss movies of interest.

FIG. 4b is a schematic diagram of an application example of the interface display method according to an example embodiment of the present disclosure. As shown in FIG. 4b, the contents of videos are displayed in various regions of an interface 404, such as videos 402(1), 402(2), 402(3), and 402(4). Moreover, when a user slides the interface 404 to browse the video content, persons in the images are displayed with the dynamic display effect in the interface 404. As shown in FIG. 4b, the persons are displayed with the dynamic display effect in a region 406 corresponding to the content. Adjacent to the human figure or person in the video 402(3), the region 406 is displayed at the interface 404 and the person is displayed with the dynamic display effect. For example, the human figure may be identified by various techniques such as AI and a corresponding video corresponding to the human figure is obtained and displayed at the region 406. Such video displayed at the region 406 may be a piece of videos extracted from the video 402(3), searched from the Internet or a database based on the identified human figure. For example, such video displayed at the region 406 is related to the role of the human figure in the video 402(3).

FIG. 4c is a schematic diagram of an application example of the interface display method according to an example embodiment of the present disclosure. As shown in FIG. 4c, the contents of videos are displayed in various regions of the interface 404, such as videos 402(1), 402(2), 402(3), and 402(4). Moreover, when a user slides the interface 404 to browse the video content, persons in the images are displayed with the dynamic display effect in the interface 404. As shown in FIG. 4c, corresponding animated images are displayed with the dynamic display effect in a region 408 corresponding to the content. Adjacent to the human figure or person in the video 402(3), the region 408 is displayed at the interface 404 and an animated image is displayed with the dynamic display effect. For example, the human figure may be identified by various techniques such as AI and a corresponding animated image corresponding to the human figure is obtained and displayed at the region 408. Such animated image displayed at the region 408 may be a piece of videos extracted from the video 402(3), searched from the Internet or a database based on the identified human figure. For example, such animated image displayed at the region 408 is related to the role of the human figure in the video 402(3).

In this way, the user may determine the content displayed in the corresponding region in the interface through the persons or animated images displayed with the dynamic display effect. The content of interest will not be missed, and the browsing and screening time is saved.

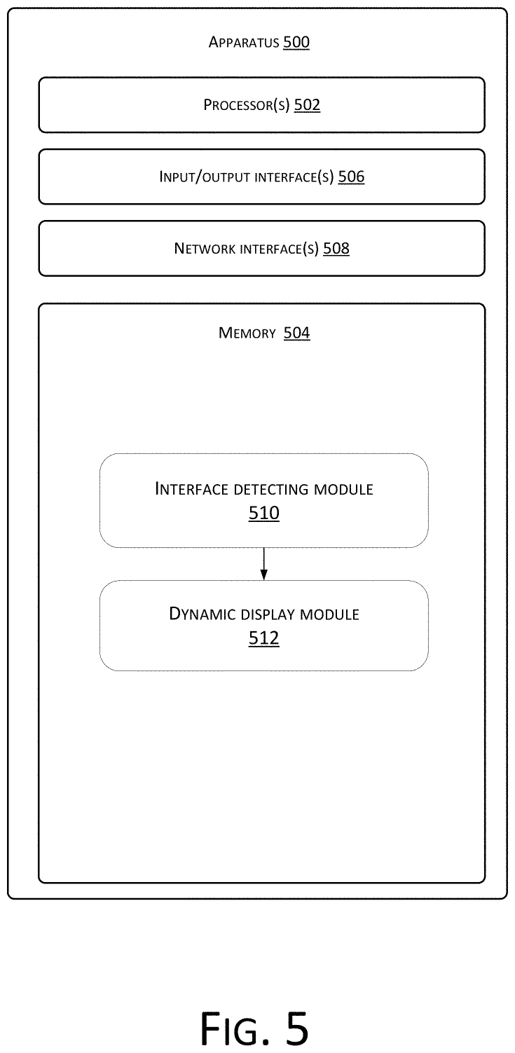

FIG. 5 is a block diagram of an interface display apparatus according to an example embodiment of the present disclosure. As shown in FIG. 5, an apparatus 500 includes one or more processor(s) 502 or data processing unit(s) and memory 504. The apparatus 500 may further include one or more input/output interface(s) 506 and one or more network interface(s) 508. The memory 612 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in the present disclosure, the computer readable medium does not include transitory media, such as a modulated data signal and a carrier.

The memory 504 may store therein a plurality of modules or units including an interface detecting module 510 and a dynamic display module 512.

The interface detecting module 510 is configured to, upon detecting a movement of an interface, determine whether the movement satisfies a trigger condition for a dynamic display effect.

The dynamic display module 512 is configured to, when the trigger condition is satisfied, display information related to content in the interface with the dynamic display effect.

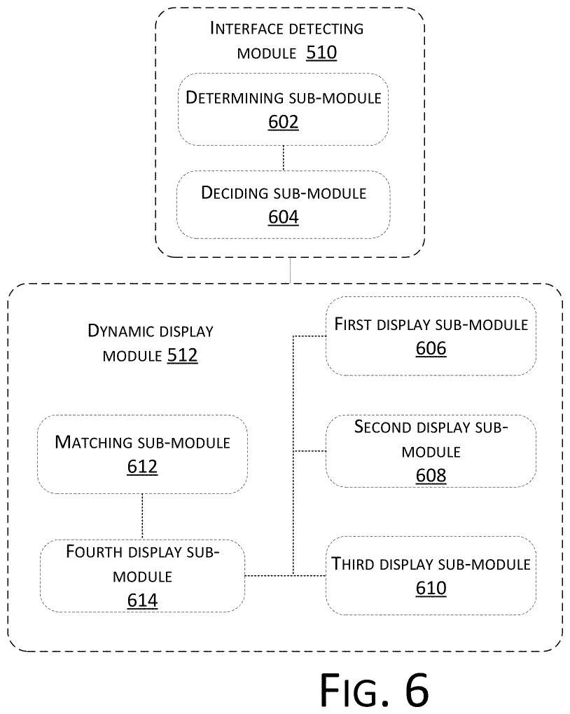

FIG. 6 is a block diagram of an interface display apparatus according to an example embodiment of the present disclosure.

In an example implementation manner, as shown in FIG. 6, the interface detecting module 510 may comprise a determining sub-module 602 and a deciding sub-module 604.

The determining sub-module 602 is configured to determine whether a speed of the interface movement exceeds a speed threshold.

The deciding sub-module 604 is configured to, when the speed of the interface movement exceeds the speed threshold, decide that the movement satisfies the trigger condition for the dynamic display effect.

In an example implementation manner, as shown in FIG. 6, the dynamic display module 512 may comprise a first display sub-module 606. The first display sub-module 606 is configured to, on an image in the interface, display a person related to the image with the dynamic display effect.

In an example implementation manner, as shown in FIG. 6, the dynamic display module 512 may comprise a second display sub-module 608. The second display sub-module 50 is configured to display an image in the interface with the dynamic display effect.

In an example implementation manner, as shown in FIG. 6, the dynamic display module 512 may comprise a third display sub-module 610. The third display sub-module 610 is configured to display an animated image in the interface, and the animated image is capable of outputting prompt information related to the content in the interface.

In an example implementation manner, as shown in FIG. 6, the dynamic display module 512 may comprise a matching sub-module 612 and a fourth display sub-module 614. The matching sub-module 612 is configured to determine matching information in the information related to the content in the interface that matches a historical behavior of the user. The fourth display sub-module 614 is configured to display the matching information with the dynamic display effect.

With regard to the apparatus in the above-described example embodiments, specific manners in which each module executes operations have been described in detail in the example embodiments of this method and will not be elaborated herein.

It should be noted that the above-described example embodiments are used as examples to describe the interface display apparatus as above, but those skilled in the art should understand that the present disclosure is not limited thereto. In fact, a user may flexibly set all parts completely according to personal preference and/or practical application scenarios, as long as they comply with the technical solutions of the present disclosure.

With the interface display apparatus according to the example embodiments of the present disclosure, when a detected movement of an interface satisfies a trigger condition for a dynamic display effect, information related to content in the interface is displayed with the dynamic display effect, which makes the interface display more interesting. Moreover, in the process of viewing an image displayed in the interface, a user may determine the content displayed in the interface by viewing the information displayed with the dynamic display effect, thereby preventing content of interest from being missed and saving viewing time.

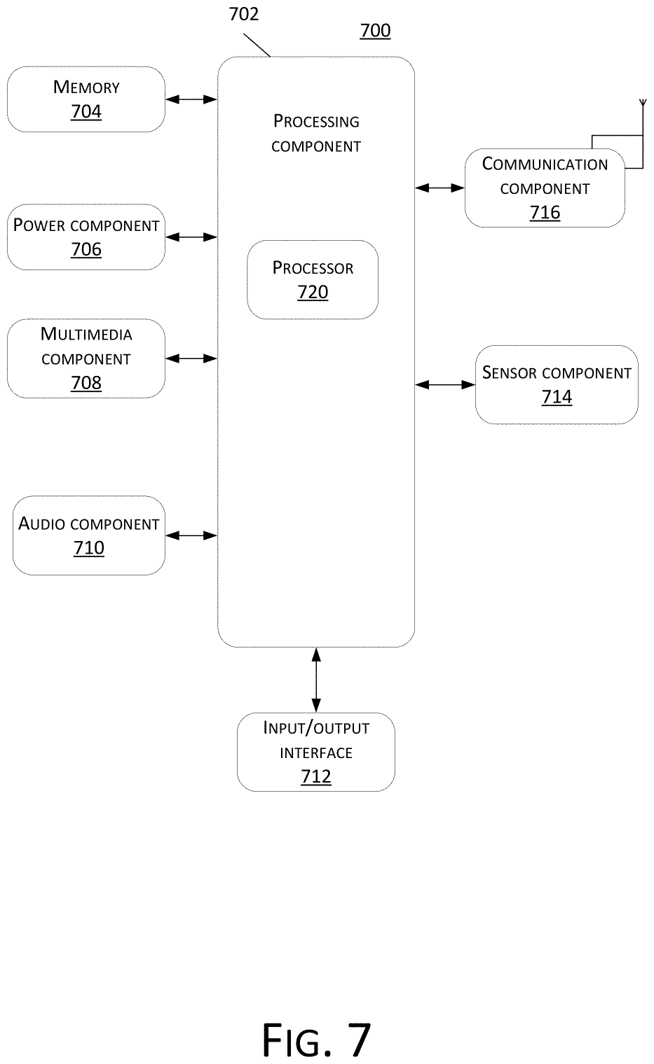

FIG. 7 is a block diagram for an interface display apparatus 700 according to an example embodiment of the present disclosure. For example, the apparatus 700 may be a mobile phone, a computer, a digital broadcast terminal, a message receiving and sending device, a game console, a tablet device, a medical device, a fitness device, a personal digital assistant, etc.

Referring to FIG. 7, the apparatus 700 may comprise the following one or more components: a processing component 702, a memory 704, a power component 706, a multimedia component 708, an audio component 710, an input/output (I/O) interface 712, a sensor component 714, and a communication component 716.

The processing component 702 typically controls overall operations of the apparatus 700, such as operations related to display, phone call, data communication, camera operations, and recording operations. The processing component 702 may comprise one or more processors 720 to execute instructions, so as to complete all or some of the steps of the above-described method. In addition, the processing component 702 may comprise one or more modules to facilitate interactions between the processing component 702 and other components. For example, the processing component 702 may comprise a multimedia module to facilitate interactions between the multimedia component 708 and the processing component 702.

The memory 704 is configured to store various types of data to support operations on the apparatus 700. Examples of the data include instructions of any application or method, contact data, phonebook data, messages, images, videos, etc. for operating on the apparatus 700. The memory 704 may be realized by any type of volatile or non-volatile storage devices or combinations thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read Only Memory (ROM), a magnetic memory, a flash memory, a magnetic disk, or an optic disc.

The power component 706 supplies electric power to various components of the apparatus 700. The power component 706 may comprise a power management system, one or more power sources, and other components related to generation, management, and distribution of electric power for the apparatus 700.

The multimedia component 708 comprises a screen that provides an output interface between the apparatus 700 and a user. In some example embodiments, the screen may comprise a liquid crystal display (LCD) and a touch panel (TP). If the screen comprises a TP, the screen may be embodied as a touch screen to receive an input signal from a user. The touchscreen panel comprises one or more touch sensors to sense touches, sliding, and gestures on the touch panel. The touch sensors may sense boundaries of touch or sliding actions, and moreover, may detect duration and pressure related to the touch or sliding operations. In some example embodiments, the multimedia component 708 comprises a front camera and/or a rear camera. When the apparatus 700 is in an operating mode, e.g., a shooting mode or video mode, the front camera and/or the rear camera may receive external multimedia data. Each of the front camera and the rear camera may be a fixed optical lens system or have a focal distance and optical zoom capabilities.

The audio component 710 is configured to output and/or input an audio signal. For example, the audio component 710 comprises a microphone (MIC), and when the apparatus 700 is in an operating mode, such as a calling mode, a recording mode, or a speech recognition mode, the microphone is configured to receive an external audio signal. The received audio signal may be further stored in the memory 704 or sent via the communication component 716. In some example embodiments, the audio component 710 further comprises a loudspeaker for outputting an audio signal.

The output (I/O) interface 712 is used for providing an interface between the processing component 702 and a peripheral interface module. The above peripheral interface module may be a keyboard, a click wheel, a button, etc. These buttons may include, but are not limited to, a homepage button, a volume button, a start button, and a locking button.

The sensor component 714 comprises one or more sensors that are used for providing status evaluation in various aspects to the apparatus 700. For example, the sensor component 714 may detect an opening/closing state of the apparatus 700 and relative positions of the components. For example, the components are a display and a keypad of the apparatus 700. The sensor component 714 may also detect position changes of the apparatus 700 or a component of the apparatus 700, presence or absence of a contact between a user and the apparatus 700, orientation or acceleration/deceleration of the apparatus 700, and temperature changes of the apparatus 700. The sensor component 714 may comprise a proximity sensor that is configured to detect the presence of a nearby object when there is no physical contact. The sensor component 714 may further comprise a light sensor, such as CMOS or CCD image sensor for use in imaging applications. In some example embodiments, the sensor component 714 may further comprise an acceleration sensor, a gyroscope sensor, a magnetic sensor, a pressure sensor, or a temperature sensor.

The communication component 716 is configured to facilitate wired or wireless communications between the apparatus 700 and other devices. The apparatus 700 may access a communication protocol-based wireless network, such as WiFi, 2G or 3G, or a combination thereof. In an example embodiment, the communication component 716 receives a broadcast signal or broadcast related information from an external broadcast management system. In an example embodiment, the communication component 716 further comprises a near field communication (NFC) module to facilitate short-distance communications. For example, the NFC module may be implemented based on a Radio Frequency Identification (RFID) technology, an Infrared Data Association (IrDA) technology, an Ultra-Wide Band (UWB) technology, a Bluetooth (BT) technology, and other technologies.

In an example embodiment, the apparatus 700 may be embodied by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic elements for implementing the above-described method.

In an example embodiment, a non-volatile computer readable storage medium is further provided, such as the memory 704 that comprises computer-readable instructions, and the computer-readable instructions may be executed by the processor 720 of the apparatus 700 to implement the above-described method.

The example embodiments of the present disclosure have been described above. The above description is example rather than exhaustive, and moreover, is not limited to the disclosed example embodiments. Without departing from the scope and spirit of the disclosed example embodiments, many modifications and variations are obvious to those of ordinary skill in the art. The terms herein are selected to explain the principles and practical applications of the example embodiments or technical improvements to the technologies on the market, or to enable others of ordinary skill in the art to understand the example embodiments disclosed herein.

The present disclosure may further be understood with clauses as follows.

Clause 1. An interface display method, wherein the method is applied to a terminal device, and the method comprises:

upon detecting a movement of an interface, determining whether the movement satisfies a trigger condition for a dynamic display effect; and

when the trigger condition is satisfied, displaying information related to content in the interface with the dynamic display effect.

Clause 2. The method according to clause 1, wherein the determining whether the movement satisfies a trigger condition for a dynamic display effect comprises:

determining whether a speed of the interface movement exceeds a speed threshold; and

when the speed of the interface movement exceeds the speed threshold, deciding that the movement satisfies the trigger condition for the dynamic display effect.

Clause 3. The method according to clause 1, wherein the displaying information related to content in the interface with the dynamic display effect comprises:

on an image in the interface, displaying a person character related to the image with the dynamic display effect.

Clause 4. The method according to clause 1, wherein the displaying information related to content in the interface with the dynamic display effect comprises:

displaying an image in the interface with the dynamic display effect.

Clause 5. The method according to clause 1, wherein the displaying information related to content in the interface with the dynamic display effect comprises:

displaying an animated image in the interface with the dynamic display effect, the animated image being capable of outputting prompt information related to the content in the interface.

Clause 6. The method according to clause 1, wherein the displaying information related to content in the interface with the dynamic display effect comprises:

determining matching information in the information related to the content in the interface that matches a historical behavior of the user; and

displaying the matching information with the dynamic display effect.

Clause 7. An interface display apparatus, comprising:

an interface detecting module configured to, upon detecting a movement of an interface, determine whether the movement satisfies a trigger condition for a dynamic display effect; and

a dynamic display module configured to, when the trigger condition is satisfied, display information related to content in the interface with the dynamic display effect.

Clause 8. The apparatus according to clause 7, wherein the interface detecting module comprises:

a determining sub-module configured to determine whether a speed of the interface movement exceeds a speed threshold; and

a deciding sub-module configured to, when the speed of the interface movement exceeds the speed threshold, decide that the movement satisfies the trigger condition for the dynamic display effect.

Clause 9. The apparatus according to clause 7, wherein the dynamic display module comprises:

a first display sub-module configured to, on an image in the interface, display a person related to the image with the dynamic display effect.

Clause 10. The apparatus according to clause 7, wherein the dynamic display module comprises:

a second display sub-module configured to display an image in the interface with the dynamic display effect.

Clause 11. The apparatus according to clause 7, wherein the dynamic display module comprises:

a third display sub-module configured to display an animated image in the interface with the dynamic display effect, the animated image being capable of outputting prompt information related to the content in the interface.

Clause 12. The apparatus according to clause 7, wherein the dynamic display module comprises:

a matching sub-module configured to determine matching information in the information related to the content in the interface that matches a historical behavior of the user; and

a fourth display sub-module configured to display the matching information with the dynamic display effect.

Clause 13. An interface display apparatus, comprising:

a processor, and

a memory configured to store a processor executable instruction,

wherein the processor is configured to execute the method according to any one of claims 1-6.

Clause 14. A non-volatile computer readable storage medium, which stores computer-readable instructions, and the computer-readable instructions implements, when being executed by a processor, the method according to any one of claims 1-6.

What is claimed is:

1. A method comprising:
upon detecting a movement of an interface, determining that the movement satisfies a trigger condition for a dynamic display effect; and
displaying information related to a content in the interface with the dynamic display effect, the displaying including:
displaying the information in a floating layer over the interface; and
displaying the information in the floating layer with the dynamic display effect.

2. The method according to claim 1, wherein the determining that the movement satisfies the trigger condition for the dynamic display effect comprises:
determining that a speed of the interface movement exceeds a speed threshold; and
deciding that the movement satisfies the trigger condition for the dynamic display effect.

3. The method according to claim 1, wherein the displaying the information related to the content in the interface with the dynamic display effect comprises:
at an image in the interface, displaying a person character related to the image with the dynamic display effect.

4. The method according to claim 1, wherein the displaying the information related to the content in the interface with the dynamic display effect comprises:
displaying an image in the interface with the dynamic display effect.

5. The method according to claim 1, wherein the displaying the information related to the content in the interface with the dynamic display effect comprises:
displaying an animated image in the interface with the dynamic display effect, the animated image outputting prompt information related to the content in the interface.

6. The method according to claim 1, wherein the displaying the information related to the content in the interface with the dynamic display effect comprises:
determining matching information in the information related to the content in the interface that matches a historical behavior of the user; and
displaying the matching information with the dynamic display effect.

7. An apparatus comprising:
one or more processors; and
one or more memories storing computer-readable instructions that, executable by the one or more processors, cause the one or more processors to perform acts comprising:
upon detecting a movement of an interface, determining that the movement satisfies a trigger condition for a dynamic display effect; and
displaying information related to a content in the interface with the dynamic display effect.

8. The apparatus according to claim 7, wherein the determining that the movement satisfies the trigger condition for the dynamic display effect comprises:
determining that a speed of the interface movement exceeds a speed threshold; and
deciding that the movement satisfies the trigger condition for the dynamic display effect.

9. The apparatus according to claim 7, wherein the displaying the information related to the content in the interface with the dynamic display effect comprises:
at an image in the interface, displaying a person character related to the image with the dynamic display effect.

10. The apparatus according to claim 7, wherein the displaying the information related to the content in the interface with the dynamic display effect comprises:
displaying an image in the interface with the dynamic display effect.

11. The apparatus according to claim 7, wherein the displaying the information related to the content in the interface with the dynamic display effect comprises:
displaying an animated image in the interface with the dynamic display effect, the animated image outputting prompt information related to the content in the interface.

12. The apparatus according to claim 7, wherein the displaying the information related to the content in the interface with the dynamic display effect comprises:
determining matching information in the information related to the content in the interface that matches a historical behavior of the user; and
displaying the matching information with the dynamic display effect.

13. One or more memories storing computer-readable instructions that, executable by one or more processors, cause the one or more processors to perform acts comprising:
upon detecting a movement of an interface, determining that the movement satisfies a trigger condition for a dynamic display effect; and
displaying information related to a content in the interface with the dynamic display effect, the displaying including:
displaying the information in a floating layer over the interface; and
displaying the information in the floating layer with the dynamic display effect.

14. The one or more memories according to claim 13, wherein the determining that the movement satisfies the trigger condition for the dynamic display effect comprises:
determining that a speed of the interface movement exceeds a speed threshold; and
deciding that the movement satisfies the trigger condition for the dynamic display effect.

15. The one or more memories according to claim 13, wherein the displaying the information related to the content in the interface with the dynamic display effect comprises:
at an image in the interface, displaying a person character related to the image with the dynamic display effect.

16. The one or more memories according to claim 13, wherein the displaying the information related to the content in the interface with the dynamic display effect comprises:
displaying an image in the interface with the dynamic display effect.

17. The one or more memories according to claim 13, wherein the displaying the information related to the content in the interface with the dynamic display effect comprises:
displaying an animated image in the interface with the dynamic display effect, the animated image outputting prompt information related to the content in the interface.

18. The one or more memories according to claim 13, wherein the displaying the information related to the content in the interface with the dynamic display effect comprises:
determining matching information in the information related to the content in the interface that matches a historical behavior of the user; and
displaying the matching information with the dynamic display effect.

19. The one or more memories according to claim 13, wherein a region corresponding to the information displayed in the dynamic display effect is opaque.

20. The one or more memories according to claim 13, wherein a region corresponding to the information displayed in the dynamic display effect is translucent.
